(19) United States
(12) Patent Application Publication
(10) Pub. No.: US 2004/0097261 A1
(43) Pub. Date: May 20, 2004

(54) Portable terminal and announcement method

(76) Inventor: Junichi Ujii, Tokyo (JP)

Correspondence Address: SCHULTE ROTH & ZABEL LLP, 919 Third Avenue, New York, NY, 10022, US

(21) Appl. No.: 10/603,244

(22) Filed: Jun. 24, 2003

(30) Foreign Application Priority Data
Jun. 26, 2002 (JP) P2002-186848

(51) Int. Cl. H04B 1/38; G06K 9/00; G06K 9/34; H04M 1/00

(52) U.S. Cl. 455/556.1; 455/550.1; 455/575.1; 455/557; 455/567

(57) ABSTRACT

A portable terminal is provided which enables people around the operator of the portable terminal (people whom the camera of the portable terminal is pointing toward) to judge whether the operator has changed it to camera mode, or is merely operating it. When it is detected that the portable terminal has been changed to the camera mode for capturing images using an image-capturing section, an announcement sound is output by using a speaker for announcing incoming-calls, or an ear speaker.

### BACKGROUND OF THE INVENTION

I. Field of the Invention

This invention relates to a portable terminal (such as a portable telephone, an information terminal (a personal digital assistant {PDA}), a voice recorder, and a notebook PC), which is capable of capturing images of persons, animals, landscapes, areas and objects, by using a camera, and more particularly, relates to a method for announcing the operating status relating to the camera mode of the portable terminal.

II. Description of the Related Art

As a result of technological advancements and market demands, there has recently been a proliferation of portable terminals, particularly portable telephones, which are fitted with a camera. Attempts are being made to increase the pixel number of recent camera-fitted portable telephones from CIF (approximately one-hundred thousand pixels) to VGA (approximately three-hundred and fifty thousand pixels). As a consequence, portable telephones are changing from those which handle images of a relatively low resolution (where it is assumed that the image taken will be the face of the original operator, or of another person nearby) to those which handle high-resolution images of another person at a greater distance. This has led to an increase in portable telephones wherein the camera is not provided on the same side (face) as the display section, as in conventional camera-fitted portable telephones, but on the opposite side from the display section, such as on the rear face of the unit (where the face containing the display section is regarded as the front face), or with a freely rotatable camera, making it possible to take photographs of subjects from a wide variety of angles. Zoom and auto-focus functions have also been added in response to market demand.

However, when the camera is provided on the rear face of the portable telephone or facing away from the operator, as described above, the camera section (lens) may point toward people even though the operator has no intention of taking their picture. Consequently, the people around the operator cannot visually judge whether he has changed his portable telephone to camera mode or is merely operating it normally, and therefore cannot know whether he is taking pictures of them when the camera (lens) of his portable telephone is pointed toward them.

To maintain polite etiquette by avoiding such inconvenience to others, sound and LED light are used to announce the moment when an image is captured, but this only indicates that an image has been captured, not that it is about to be captured. Furthermore, announcement by light has a drawback that it cannot be noticed by the person being photographed when he has his back to the operator.

Providing cameras on portable telephones, which are carried by their users at all times, has brought the advantage of enabling images to be captured by using the cameras at any time and any place; however, since users are relied upon to refrain from using camera mode at their own discretion, a social problem has been caused by those who use camera mode without considering their surroundings.

### SUMMARY OF THE INVENTION

To solve the problems mentioned above, a first aspect of the present invention provides an announcement method for a portable terminal comprising an image-capturing section, and outputs a predetermined announcement sound at the time of changing to camera mode, which uses the image-capturing section.

This enables people whom the camera is pointed toward to easily judge whether the operator of a portable telephone has changed it to camera mode. Even when the camera of the portable telephone is not within their field of vision, they can easily be made aware of the presence of the portable telephone which has been changed to camera mode. In addition, camera mode is a mode for capturing still images and/or moving images.

According to a second aspect of this invention, the predetermined announcement sound is output each time a fixed period of time has elapsed in the camera mode. This makes it possible to announce to the surrounding people not only that the portable telephone has been changed to camera mode, but that it remains in camera mode.

According to a third aspect of this invention, the announcement sound is output from a speaker for announcing incoming-calls or an ear speaker. Using the speaker for announcing incoming-calls, or the ear speaker, as a dual-purpose speaker in this way reduces the necessary circuit space and the cost.

According to a fourth aspect of this invention, in the camera mode, the announcement sound is not output while recording an image captured from the image-capturing section. This prevents the microphone from picking up the sound while capturing a moving image (including audio sound).

According to a fifth aspect of this invention, the announcement sound is output only in a case where the illuminance around the portable terminal is less than a predetermined brightness. This enables the presence of the portable telephone, which has been changed to the camera mode, to be easily identified even in dark places where the user cannot easily be recognized.

A sixth aspect of this invention provides an announcement method for a portable terminal comprising an image-capturing section. The method comprises outputting a predetermined announcement sound when an image-capture button has been pressed after the portable terminal has been changed to a camera mode, which uses the image-capturing section. This enables the person being photographed to be notified of the timing just before capturing the image.

According to a seventh aspect of this invention, the output level of the predetermined announcement sound is restricted to a fixed output level. Therefore, since the user cannot freely modify the output level of the announcement sound, there is no danger that he will intentionally or unintentionally lower the output level to such an extremely low level that the announcement sounds can no longer be heard.

According to an eighth aspect of this invention, the predetermined announcement sound, or an announcement sound notifying that an image has been captured, is output when the image-capturing button is fully pressed just after being half-pressed. This prevents the joint output of a predetermined announcement sound indicating the timing just before capturing an image, and a shutter sound indicating that the image has been captured, when the image-capturing button has been fully pressed just after being half-pressed.

As described above, the portable telephone device of this invention obtains the following advantages.

(1) A person whom the camera is pointed toward can easily judge whether the user of the portable telephone has changed it to camera mode.

(2) Even when the camera of the portable telephone is not within the persons field of vision, he can easily be made aware of the presence of the portable telephone which has been changed to camera mode.

(3) By announcing the camera mode at fixed intervals of time, it is possible to announce to people nearby not only that the portable telephone is changed to the camera mode, but also that it remains in camera mode.

(4) By not generating the announcement sounds while capturing a moving image (including audio sound), bad influences on the moving image (which also records sound) is prevented.

(5) When the measurement taken by the illuminance sensor indicates that the area around the portable telephone is dark, active announcements are made, making it possible to notify people nearby that the portable telephone is changed to camera mode, even in dark places and the like, where such recognition is difficult.

(6) The person to be photographed can be notified of the timing just before capturing the image.

(7) Using the speaker for announcing incoming-calls, or the ear speaker, as a dual-purpose speaker reduces the circuit space and the cost.

### BRIEF DESCRIPTION OF THE DRAWINGS

FIG. 1 is a diagram showing the front face of the external appearance of a camera-fitted portable telephone according to an embodiment of this invention;

FIG. 2 is a diagram showing the rear face of the external appearance of a camera-fitted portable telephone according to the embodiment of this invention;

FIG. 3 is a diagram showing the circuit constitution of a camera-fitted portable telephone according to the embodiment of this invention; and

FIG. 4 is a flowchart showing the operation of a speaker for announcing incoming calls according to the embodiment of this invention.

### DETAILED DESCRIPTION OF THE PREFERRED EMBODIMENTS

An embodiment of this invention will be explained using the diagrams.

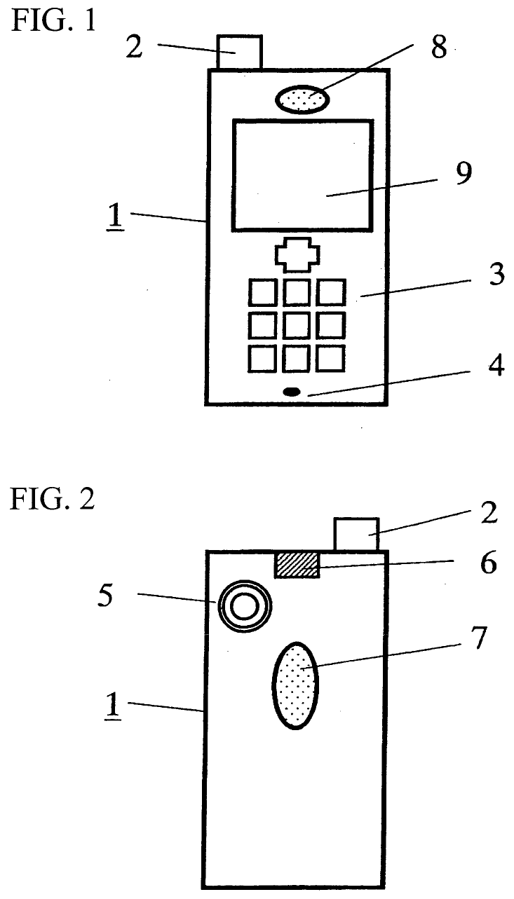

FIGS. 1 and 2 show the external appearance of a camera-fitted portable telephone according to an embodiment of this invention. In FIGS. 1 and 2, reference numeral 1 represents a portable telephone main body. The portable telephone main body 1 comprises an antenna 2, an operation section 3, a microphone 4, a camera section 5, an LED for incoming calls 6, a speaker for announcing incoming calls 7, an ear speaker 8, and a display section 9, and thus has the basic constitution of a portable telephone with a camera fitted to its rear face (where the face having the display section is regarded as the front face).

The operation section 3 is used for making a variety of operation commands. The operation section 3 comprises various types of buttons and operation keys such as a ten-button numeric keypad, a power button, an on-hook/off-hook button, a shutter button, and a function selector button (function key). The display section 9 comprises an LCD (liquid crystal display), and display menu screens, such as telephone numbers, camera mode, and the like. Images such as those captured and recorded by the camera section 5 are also displayed in the display section 9. The camera section 5 uses a CCD image-capturing device, and is provided on the opposite face to that of the display section 9 (i.e. on the rear face).

The LED for incoming calls 6 notifies the user of incoming calls by lighting up or flashing when an incoming call is received. Although the display section 9 also notifies the user of incoming calls by lighting up and flashing, the user cannot notice the notification by the display section 9 when the display section 9 is hidden from the user's view. For this reason, the LED for incoming calls 6 is arranged so that the user can notice incoming calls even when the display section 9 is hidden from the user's view, making it possible for the user to notice the incoming calls whichever face of the portable telephone he is looking at. Therefore, the LED for incoming calls 6 and the camera section 5 should preferably be provided close together.

The speaker for announcing incoming calls 7 normally notifies the user that an incoming call has been received by means of a melody or other sound, but is also used for other purposes, such as announcement by an alarm. Therefore, the speaker used as the speaker for announcing incoming calls 7 has a higher output level than that of the ear speaker 8, since it announces incoming calls when the portable telephone is located inside the users pocket, the user's bag or other location. The speaker for announcing incoming calls 7 used in the above situation is provided on the opposite face to that of the ear speaker 8 (i.e. on the rear face).

A portable terminal normally has a plurality of applications (e-mail, internet browser, camera mode), and the camera-fitted portable telephone described above has two aspects of usage (operating statuses): (1) when used as a normal telephone (including data communications, e-mail, internet browser), and (2) when used to capture images by using the camera section 5 (camera mode). The difference between these two aspects of usage is that, when used as a normal telephone, the portable terminal is used only by the person operating the telephone or by the person operating the telephone and the person he is speaking to, any third party in the vicinity of the portable terminal being irrelevant; however, when capturing an image by using the camera section 5, a third party in the vicinity of the portable terminal becomes involved in the operation.

In addition to the operating statuses, which express the above modes of usage, as will be explained below, there are other types of operating status which express processing states during camera mode using the camera section 5, such as preparing to capture an image (just before image-capturing) and just after capturing the image.

### Camera Mode

Camera Mode is a mode which uses the camera section 5 (changed from a mode which uses the portable terminal as a normal telephone). The user changes to camera mode by operating the menu screen. Alternatively, there are methods of changing to camera mode mechanically. It is still possible to receive calls and other communications during camera mode.

### Preparing to Capture an Image

### Just Before Capturing an Image

Auto focus starts when a shutter button (image-capturing button) is half-pressed, and the focus is locked at the completion of auto focus. The image on the screen is captured by pressing the shutter button further. That is, this is the period from pressing the shutter button to the start of recording the image. When the shutter button is fully pressed without being half-pressed, auto focus starts first, and, when focusing is complete, the image is captured. Therefore, in this case, the period lasts from just after pressing the shutter button to the start of recording the image.

### Just After Capturing an Image

This is the period from the start of recording the captured image to displaying it on the display section. Alternatively, it is the period of a few seconds after the start of recording and displaying.

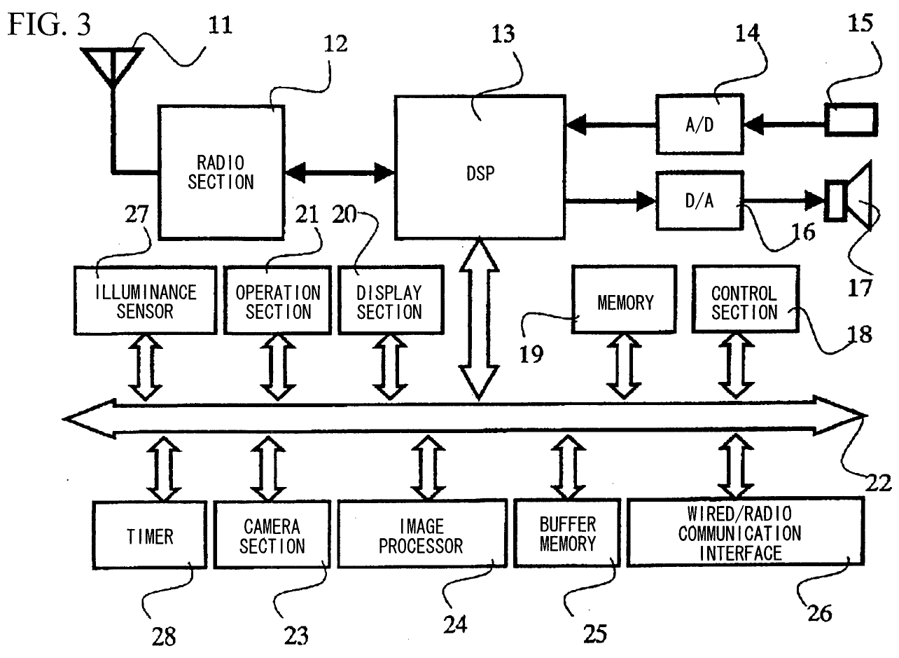

FIG. 3 is a block diagram showing the circuit constitution of the camera-fitted portable telephone according to this invention. The portable telephone comprises various types of function blocks connected to a control section (Central Processing Unit) 18, which controls the overall portable telephone.

An antenna 11 transmits and receives radio waves used in communications. A memory 19 comprises, for example, a ROM or nonvolatile RAM, and stores programs, which are executed by the control section 18 and a digital signal processor (DSP) 13, in addition to data such as various set values, transmitted and received mails, incoming-call sound data, address book data, image data, LED light (flash) patterns for incoming calls, predetermined announcement sounds, and other data. A radio section 12 modulates control signals, audio signal, and other signals, which it has received from the DSP 13 in accordance with a predetermined modulation scheme, and outputs them to the antenna 11, and, in addition, demodulates receiver signals from the antenna 11 and outputs the demodulated signals to the DSP 13.

A D/A converter 16 converts digital audio signals, incoming-call sounds, and other signals, which are output from the DSP 13, into analog audio signals, and supplies these to a speaker 17. The speaker maybe a speaker for announcing incoming calls 7 or an ear speaker 8 or there may be plural speakers. Similarly, an A/D converter 14 converts analog audio signals, input from a microphone 15, into digital audio signals, and supplies them to the DSP 13. An operation section (selecting section) 21 comprises, for example, a ten-button numeric keypad (0 to 9), symbol keys such as the * key and the # key, an on-hook button, an off-hook button, a power button, a shutter button, a function selector button (function key), and other keys, and functions as an interface between the user and the portable telephone.

A display section 20 is comprised of, for example, a liquid crystal display or a liquid crystal touch panel, and displays contents of operations performed by the user, an operation menu, an address book, the state of the portable telephone, the time, and other displays.

A camera section 23 comprises an image-capturing device, such as a CCD, and an optical system, such as a lens. An image processor 24 processes, formats, compresses, and decompresses, image data. A buffer memory 25 is a memory for momentarily storing the image data output from the CCD, and is used in absorbing differences in the input and output speeds of the image data to and from a memory card (not shown), and differences in the processing speeds of the CPU 18 and the DSP 13. The buffer memory 25 is also used when, for example, the portable telephone performs a video telephone function.

An illuminance sensor 27 measures the luminance of surrounding light in order to reduce the power consumption of the back light, the LED, and other light emitting elements, which are used in the display section and the LED for incoming calls or other visual indicators. The back light, the LED, and other visual indicators, are switched ON and OFF in accordance with the measurements taken by the illuminance sensor 27. A timer 28 measures a fixed period of time, described later.

A wired/radio communication interface 26 communicates with external devices, communicating over comparatively short distances (approximately ten meters) in the case of the radio communication interface, and comprises an infrared communication interface, such as an IrDA, a communication interface using radio waves, such as a Bluetooth, or other communication technology.

The control section (CPU) 18 has a microprocessor (MPU) and other circuitry, and controls the operations of the entire portable telephone. The camera section 23, the image processor 24, the buffer memory 25, the memory 19, the wired/radio communication interface 26, and other elements, are connected to the control section 18 via a bus 22.

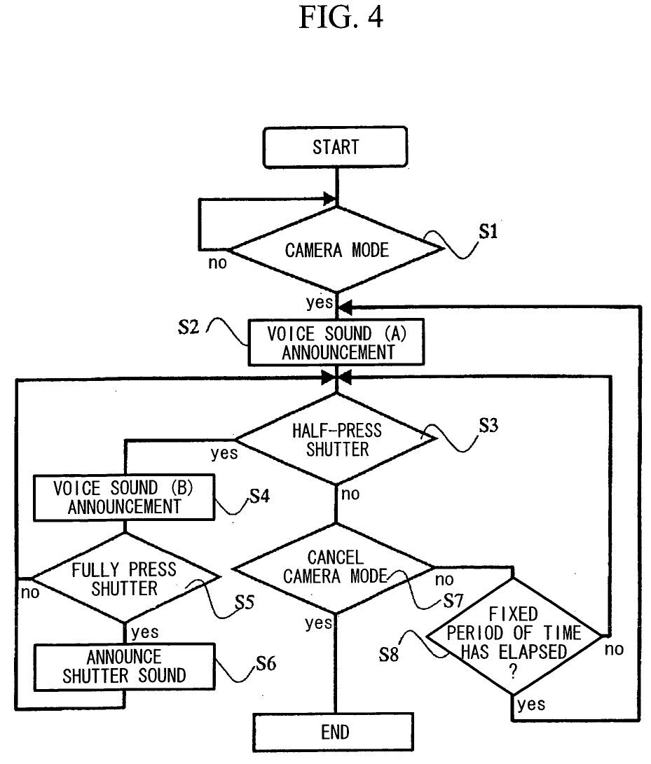

Subsequently, an operation of the speaker for announcing incoming-calls according to the present invention will be explained using the flowchart of FIG. 4.

In step S1, the control section 18 of the-portable telephone checks the timing for changing to camera mode. Camera mode is the mode in which an image taken by the camera section 23 is displayed on the display section 20, and this image can be captured at any time by pressing the shutter. This includes not only capturing still images, but also video telephone mode for capturing moving images and transmitting the captured images to a communication partner.

When the change to camera mode has been detected in the check process described above, the control section 18 proceeds from step S1 to step S2, and announces the change to camera mode by transmitting a voice sound A (e.g. “This is Camera Mode”) through the speaker for announcing incoming-calls 7. Then, in step S3, the control section 18 checks the timing of when the shutter button is half-pressed. When the control section 18 has detected in the check process in step S3 that the shutter button has been half-pressed, the CPU 18 proceeds from step S3 to step S4, and announces with a voice sound B (e.g. ‘Taking a photograph”, or “Smile please!”) via the speaker for announcing incoming-calls 7 that indicates the timing just before capturing an image. Half-pressing the shutter button indicates that, for example, auto focusing is being carried out, and the announcement of the voice sound B can be used to notify people around the user of the timing just before taking a photograph.

Then, in step S5, the control section 18 checks the timing of fully pressing the shutter button. When the control section 18 has detected in the check process in step S5 that the shutter button has been fully pressed, the processing of the control section 18 proceeds from step S5 to step S6, and announces that an image has been captured by means of a shutter sound via the speaker for announcing incoming-calls 7. Incidentally, the processing performed in step S5 includes checking whether the half-press of the shutter button has been cancelled. When it is detected that the half-press of the shutter button has been cancelled, the processing returns to step S3.

When the shutter button has been fully pressed just after being half-pressed, the voice sound B and the shutter sound would be announced simultaneously; and for this reason, it is acceptable to announce only either one of them.

When the shutter button is not detected to have been half-pressed in step S3, in step S7, the control section 18 judges whether a command to cancel camera mode has been issued. When there is no such command, the processing proceeds from step S7 to step S8, and judges whether a fixed period of time has elapsed since the change to camera mode. When the fixed period of time has elapsed, processing returns to step S2 and the voice sound A is announced. When the fixed period of time has not elapsed, processing returns to step S3. When a command to cancel camera mode is detected in step S7, the camera mode is terminated.

Although not shown in the flowchart of FIG. 4, when capturing a moving image, it is possible to stop the voice sound A, announced after the fixed period of time has elapsed, by not performing the process of step S8; this avoids spoiling the moving image, which also records sound.

In this way, as a result of the voice sound announcements, the person whom the camera section (lens) is pointed toward can notice that the user of the portable telephone has changed it to camera mode, and that the operator is about to take a photograph. Moreover, even when the person has not noticed that the camera section is pointing toward himself (e.g. when his back is facing the camera), the voice sound announcements make him aware of the camera mode. The voice sound announcements also encourage the user of the portable telephone to take care so as not to point the camera section toward other people inconsiderately.

The illuminance sensor may be controlled so that the voice sound announcement indicating the portable telephone has changed to camera mode is generated only when the area around the portable telephone is dark. This makes it possible to actively notify people nearby that the portable telephone is changed to camera mode in dark places, where such recognition is difficult. A dark level of illuminance around the portable telephone (less than a predetermined brightness) may be defined as that in an environment where, for example, the letters on the display section cannot be read clearly without the backlight, that is, when the backlight or LED is lighted up in accordance with the measurement of the surrounding luminance taken by the dual-purpose illuminance sensor.

In this embodiment, camera mode and the moment just before capturing an image are announced by voice sounds, but the invention is not limited to voice sounds, and anything which can be announced by sound is acceptable. That is, although this embodiment describes voice sound announcements, repeated after a predetermined fixed period of time has elapsed, it also includes sounds which are generated singularly (e.g. beeps), sound patterns, melodies, and consecutive sounds, and other audible indicators. Furthermore, the output level from the speaker should preferably be constant, and not freely modifiable by the user. The sounding body for announcing the sounds is not limited to the speaker for announcing incoming-calls, and may, for example, comprise the ear speaker, a ringer, or other audible indicators.

In this embodiment, the camera section is provided on the face (rear face) opposite to that of the display section, but this invention includes any portable terminal wherein the camera (lens) faces towards people even though the operator has no intention of taking their photograph, and is not limited to the above embodiment. The camera section may be a removable one.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An announcement method for a portable terminal comprising an image-capturing section, the method comprising outputting a predetermined announcement sound when the portable terminal has been changed to a camera mode, which uses the image-capturing section.

2. The announcement method for a portable terminal of claim 1, wherein the predetermined announcement sound is output each time a fixed period of time has elapsed in the camera mode.

3. The announcement method for a portable terminal of claim 1, wherein the announcement sound is output from one of a speaker for announcing incoming-calls and an ear speaker.

4. The announcement method for a portable terminal of claim 1, wherein, in the camera mode, the announcement sound is not output while recording an image captured by the image-capturing section.

5. The announcement method for a portable terminal of claim 1, wherein the announcement sound is output only in a case where the luminance around the portable terminal is less than a predetermined brightness.

6. The announcement method for a portable terminal of claim 1, wherein the output level of the predetermined announcement sound is restricted to a fixed output level.

7. An announcement method for a portable terminal comprising an image-capturing section, the method comprising outputting a predetermined announcement sound when an image-capture button has been pressed after the portable terminal has been changed to a camera mode, which uses the image-capturing section.

8. The announcement method for a portable terminal of claim 7, wherein the predetermined announcement sound, or an announcement sound notifying that an image has been captured, is output when the image-capturing button is fully pressed just after being half-pressed.

9. A portable terminal comprising:
an image-capturing section;
a selecting section which selects a camera mode for using the image-capturing section;
a sounding body; and
a control section which outputs a predetermined announcement sound from the sounding body when it has been detected that the selecting section has selected the camera mode.

10. The portable terminal of claim 9, further comprising a timing section which measures time, wherein the timing section outputs a signal each time a fixed period of time elapses after it was detected that the selecting section has selected the camera mode, and wherein the control section causes the sounding body to output the predetermined announcement sound whenever the signal is output from the timing section.

11. The portable terminal of claim 9, wherein the sounding body comprises one of a speaker for announcing incoming-calls and an ear speaker.

12. The portable terminal of claim 9, further comprising a recording section which records an image input via the image-capturing section, wherein the control section judges whether the recording section is recording an image, and controls the sounding body so as not to output the predetermined announcement sound while the recording section is recording.

13. The portable terminal of claim 9, further comprising a measuring section for measuring the luminance of surrounding light, wherein the control section allows the sounding body to output the predetermined announcement sound only when the measuring section has measured light of less than a predetermined luminance.

14. The portable terminal of claim 9, wherein the control section restricts the output level of the predetermined announcement sound to a fixed output level.

15. A portable terminal comprising:
an image-capturing section;
a selecting section which selects a camera mode for using the image-capturing section;
a sounding body;
an image-capturing button for operating image-capturing;
a control section which outputs a predetermined announcement sound from the sounding body when it has detected that the image-capturing button has been pressed, after it has detected that the selecting section has selected the camera mode.

16. The portable terminal of claim 15, wherein the control section outputs the predetermined announcement sound, or an announcement sound notifying that an image has been captured, from the sounding body when the image-capturing button is fully pressed just after being half-pressed.
